(19) United States
(12) Patent Application Publication
(10) Pub. No.: US 2025/0028233 A1
(43) Pub. Date: Jan. 23, 2025

(54) OPTICAL ELEMENT AND PROJECTION APPARATUS USING THE SAME

(71) Applicant: STANLEY ELECTRIC CO., LTD., Tokyo (JP)

(72) Inventor: Atsushi YAMAMOTO, Tokyo (JP)

(73) Assignee: STANLEY ELECTRIC CO., LTD., Tokyo (JP)

(21) Appl. No.: 18/775,046

(22) Filed: Jul. 17, 2024

(30) Foreign Application Priority Data
Jul. 21, 2023 (JP) 2023-119401

(51) Int. Cl. G03B 21/20

(52) U.S. Cl. CPC G03B 21/208

(57) ABSTRACT

An optical element, which is arranged between a light source and a light deflector reflecting and two-dimensionally deflecting incident light, includes: a first region on which light from the light source is caused to be incident and which emits the light to the light deflector; and a second region which is different from the first region, on which light reflected and two-dimensionally deflected by the light deflector is incident, and which emits the light to an outside, and an optical surface having a different optical action is provided on at least one side of an incident side and an emission side of the first region and an incident side and an emission side of the second region.

### INCORPORATION BY REFERENCE

This application is based upon and claims the benefit of priority from Japanese patent application No. 2023-119401, filed on Jul. 21, 2023, the disclosure of which is incorporated herein in its entirety by reference.

### BACKGROUND

The present disclosure relates to an optical element and a projection apparatus using the same.

A projection apparatus has been known that includes a light source, a light deflector which two-dimensionally deflects incident light, and an optical element (prism) which is arranged between the light source and the light deflector (for example, see Japanese Patent No. 6457185).

### SUMMARY

However, in Japanese Patent No. 6457185, a measure against stray light due to an optical element is taken in consideration, but reduction in a projection angle of view due to the optical element and optical aberrations are not deeply taken into consideration.

The present disclosure has been made for solving such problems, and an object thereof is to provide an optical element and a projection apparatus using that which properly suppress various aberrations, easily obtain a high quality projection image, and can suppress reduction in an angle of view due to the optical element.

An optical element according to the present disclosure is an optical element being arranged between a light source and a light deflector reflecting and two-dimensionally deflecting incident light, the optical element including: a first region on which light from the light source is caused to be incident and which emits the light to the light deflector; and a second region which is different from the first region, on which light reflected and two-dimensionally deflected by the light deflector is incident, and which emits the light to an outside, in which an optical surface having a different optical action is provided on at least one side of an incident side and an emission side of the first region and an incident side and an emission side of the second region.

In the optical element, the optical surface may be an optical surface having refractive power.

In the optical element, an optical surface having refractive power may be provided at least on the emission side of the second region.

In the optical element, an optical surface having refractive power may be provided at least on the incident side of the first region.

In the optical element, at least optical actions of the incident side of the first region and of the emission side of the second region may be different from each other.

The optical element may be configured by using at least two or more kinds of materials.

A projection apparatus according to the present disclosure includes: a light source; a light deflector which reflects and two-dimensionally deflects incident light; and the optical element.

The present disclosure can provide an optical element and a projection apparatus using the same which properly suppress various aberrations, easily obtain a high quality projection image, and can suppress reduction in an angle of view due to the optical element.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is an outline configuration diagram of a projection apparatus 10;

FIG. 2 is a perspective view of the projection apparatus 10;

FIG. 3 is a cross-sectional view taken along A-A in FIG. 2;

FIG. 4 illustrates a first modification of an optical element 50;

FIG. 5A illustrates a second modification of the optical element 50;

FIG. 5B illustrates a third modification of the optical element 50;

FIG. 6A illustrates a fourth modification of the optical element 50;

FIG. 6B illustrates a fifth modification of the optical element 50;

FIG. 7 illustrates a sixth modification of the optical element 50;

FIG. 8 illustrates a seventh modification of the optical element 50; and

FIG. 9 illustrates an eighth modification of the optical element 50.

### DESCRIPTION OF EMBODIMENTS

A projection apparatus 10 to which an optical element 50 as an embodiment of the present disclosure is applied will hereinafter be described with reference to the attached drawings. In the drawings, the same reference characters will be given to corresponding configuration elements, and descriptions thereof will not be repeated.

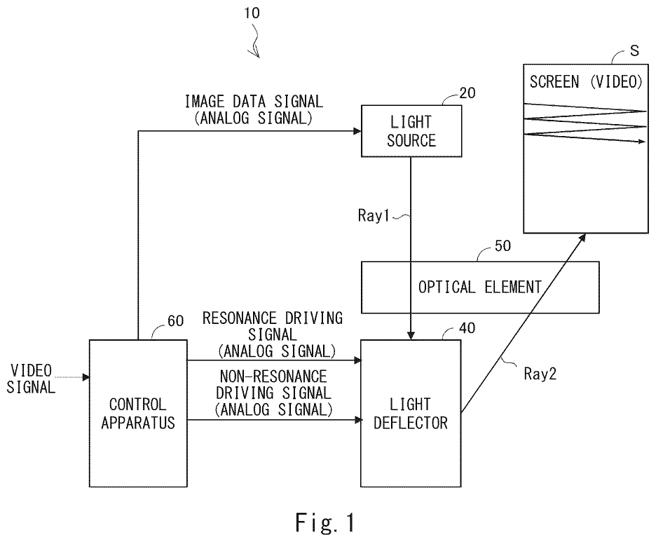

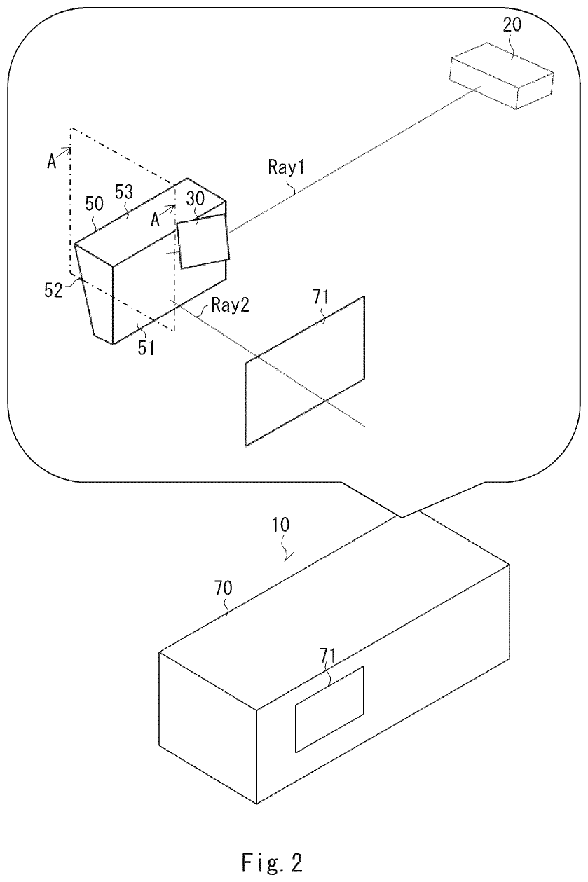

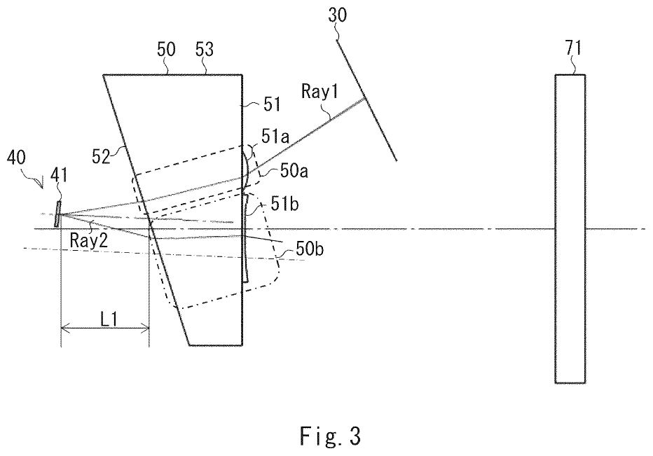

FIG. 1 is an outline configuration diagram of the projection apparatus 10, FIG. 2 is a perspective view of the projection apparatus 10, and FIG. 3 is a cross-sectional view taken along A-A in FIG. 2.

The projection apparatus 10 is a laser scanning projector (or pico-projector) that forms (projects) a video on a screen S by a laser beam which is two-dimensionally deflected (two-dimensionally scanning).

As illustrated in FIG. 1 and FIG. 2, the projection apparatus 10 includes a light source 20, a reflection surface 30 (not illustrated in FIG. 1), a light deflector 40, the optical element 50, and a control apparatus 60. The light source 20, the reflection surface 30, the light deflector 40, the optical element 50, and the control apparatus 60 are arranged in a housing 70. The housing 70 is a rectangular-cuboidal housing, in one surface (side surface) of which a light emission opening 71 through which a laser beam Ray2 is emitted is formed, the laser beam Ray2 being reflected and two-dimensionally deflected by the light deflector 40.

The light source 20 is a light source module which emits one laser beam Ray1 (ray) resulting from combination (multiplexing) of laser beams of three primary colors (RGB). The laser beam Ray1 emitted by the light source 20 is reflected by the reflection surface 30, is transmitted through the optical element 50, and is incident on the light deflector 40 (a mirror unit 41).

The reflection surface 30 is arranged on an optical path of the laser beam Ray1 emitted by the light source 20 but is not a required configuration and may be present or may be omitted in a case where the reflection surface 30 is not necessary.

As illustrated in FIG. 3, the light deflector 40 is arranged on an opposite side to the light emission opening 71 with respect to the optical element 50. In this case, the light deflector 40 is arranged such that the laser beams Ray1 and Ray2, which are transmitted through the optical element 50, do not overlap each other.

It is desirable that a distance L1 between the light deflector 40 and the optical element 50 be as short as possible, and it is desirable that the light deflector 40 be arranged in the vicinity of the optical element 50 via a space. Accordingly, size reduction of the optical element 50 and further size reduction of the projection apparatus 10 become possible.

The optical element 50 is formed of a transparent resin such as an acrylic resin or a polycarbonate or of glass. The optical element 50 is formed by joining together a trapezoidal prism that includes a first surface 51 and a second surface 52, which are not parallel with each other, and a transparent body 53 between the first surface 51 and the second surface 52 and lens units that have refractive power and are denoted by reference characters 51a and 51b, for example. Because an optical path which guides a ray to the light deflector 40 and guides the ray from the light deflector 40 to a projection surface can be realized with one optical element 50, size reduction of the projection apparatus 10 becomes possible. Note that the optical element 50 is not limited to the trapezoidal prism and the lens units having refractive power, and both of those may integrally be shaped.

In the following, in the optical element 50, a portion on which the laser beam from the light source 20 (the laser beam Ray1 reflected by the reflection surface 30) is caused to incident and which emits the laser beam to the light deflector 40 will be referred to as a first region 50a, and a portion which is different from the first region 50a, on which the laser beam Ray2 reflected by the light deflector 40 and two-dimensionally deflected by the light deflector 40 is incident, and which emits the laser beam Ray2 to an outside will be referred to as a second region 50b. The first region 50a is an optical element portion in a range surrounded by a dotted line indicated by a reference character 50a in FIG. 3. Similarly, the second region 50b is an optical element portion in a range surrounded by a dashed-dotted line indicated by a reference character 50b in FIG. 3.

The first surface 51 includes a first optical surface 51a and a second optical surface 51b arranged below that, but arrangement of the first optical surface 51a and the second optical surface 51b does not necessarily have to be in an up-down direction because the arrangement can be changed in accordance with a position of the light source 20 and an emission direction.

The first optical surface 51a is an optical surface, which has refractive power, of the first region 50a on an optical element incident side and is a surface having positive refractive power in FIG. 3. The first optical surface 51a is provided in a region, on which the laser beam Ray1 reflected by the reflection surface 30 is incident, in the first surface 51. The first optical surface 51a is provided so that the laser beam Ray1, which is reflected by the reflection surface 30 and is transmitted through the optical element 50 (first region 50a), is incident on a desired spot in the light deflector 40 (mirror unit 41) while having desired optical performance, for example. An optimal ray is incident on the light deflector 40 (mirror unit 41), and a projection image can thereby be improved.

On the other hand, the second optical surface 51b is an optical surface, which has refractive power, of the second region 50b on an optical element emission side and is a surface having negative refractive power in FIG. 3. The second optical surface 51b is provided in a position, below the first optical surface 51a, in the first surface 51, that is, in a region from which the laser beam Ray2, which is reflected and two-dimensionally deflected by the light deflector 40 and is transmitted through the optical element 50 (second region 50b), is emitted. The second optical surface 51b has effects of expanding an emitted ray and of enlarging the projection image. By using an aspherical surface or the like, and correction of a distortion aberration, a trapezoid, and so forth can be performed.

As described above, in the present embodiment, the first region 50a of the optical element 50 through which the laser beam from the light source 20 is transmitted and the second region 50b of the optical element 50 through which the laser beam, which is reflected and two-dimensionally deflected by the light deflector 40, is transmitted are caused to have optical functions which are different from each other, various aberrations can thereby properly be suppressed, a high quality projection image can easily be obtained, and reduction in an angle of view due to the optical element 50 can be suppressed. A proper projection image and a wide angle of view can be secured.

Next, modifications will be described.

In the above embodiment, a description is made about an example where the optical element 50 is configured by using one kind of material, but this is not restrictive. For example, in order to decrease color aberrations, the optical element 50 may be configured by using two or more kinds of materials. For example, the optical element 50 may be configured such that materials, which are different from each other, are respectively used for prism portions 53, 51a, and 51b and the prism portions 53, 51a, and 51b are combined together via adhesion surfaces.

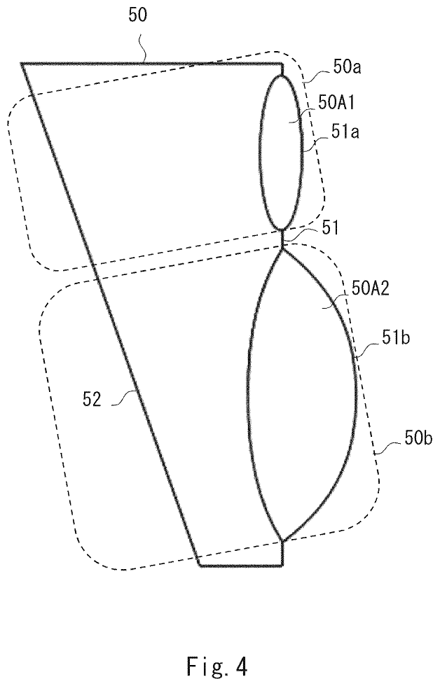

FIG. 4 illustrates a first modification of the optical element 50.

As illustrated in FIG. 4, optical surfaces having positive refractive power may be used for both of the first optical surface 51a and the second optical surface 51b; appropriate refractive power is arranged for each of those, and correction of various aberrations, shape adjustment of the ray from the light source 20, and so forth can thereby be performed.

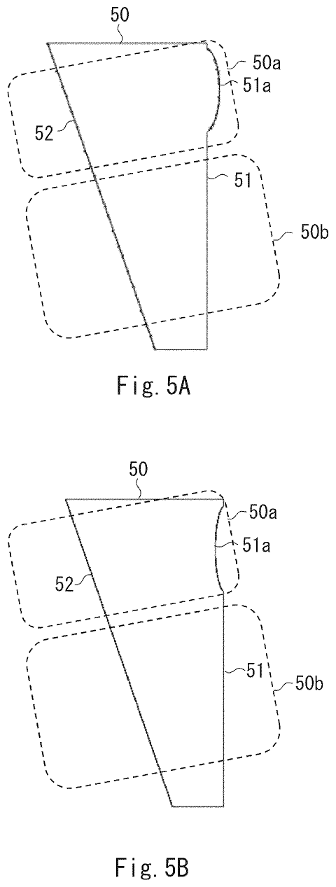

FIG. 5A illustrates a second modification of the optical element 50, and FIG. 5B illustrates a third modification of the optical element 50.

As illustrated in FIG. 5A, the second optical surface 51b of the second region 50b may be omitted. In this case, the first optical surface 51a of the first region 50a on an incident side may be a surface having negative refractive power as illustrated in FIG. 5B.

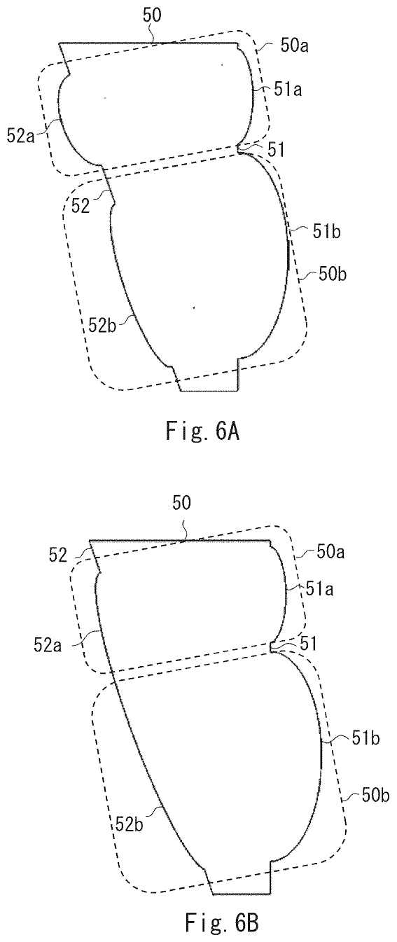

FIG. 6A illustrates a fourth modification of the optical element 50, and FIG. 6B illustrates a fifth modification of the optical element 50.

As illustrated in FIG. 6A, a third optical surface 52a having refractive power may be provided on a light deflector side of the first region 50a. A fourth optical surface 52b having refractive power may be provided on the light deflector side of the second region 50b. As described above, it is sufficient that the optical surface having refractive power is provided on at least one side of the incident side and an emission side of the first region 50a and an incident side and an emission side of the second region 50b.

As illustrated in FIG. 6B, the third optical surface 52a of the first region 50a and the fourth optical surface 52b of the second region 50b do not necessarily have to have a region boundary, and if possible, those may have a continuous surface as the optical surface 52a and the optical surface 52b in FIG. 6B.

In the above embodiment and each of the above modifications, descriptions are made about examples where as the first optical surface 51a to the fourth optical surface 52b, convex lens surfaces (or concave lens surfaces) are used, but this is not restrictive. That is, the first optical surface 51a to the fourth optical surface 52b may be any optical surfaces as long as those have different optical actions. For example, each of the first optical surface 51a to the fourth optical surface 52b may be a lens surface having positive refractive power, a lens surface having negative refractive power, or a diffusion surface. Each of the first optical surface 51a to the fourth optical surface 52b may be a freeform surface, a curved surface, a microlens, or a Fresnel lens. Each of the first optical surface 51a to the fourth optical surface 52b may be a spherical lens or an aspherical lens. Note that the different optical action means an optical action which is different from simple refraction. For example, as for the first optical surface 51a and the second optical surface 51b, the different optical action means an optical action which is different from that of the first surface 51 as a base surface in which the first optical surface 51a and the second optical surface 51b are provided. Similarly, as for the third optical surface 52a and the fourth optical surface 52b, the different optical action means an optical action which is different from that of the second surface 52 as a base surface in which the third optical surface 52a and the fourth optical surface 52b are provided.

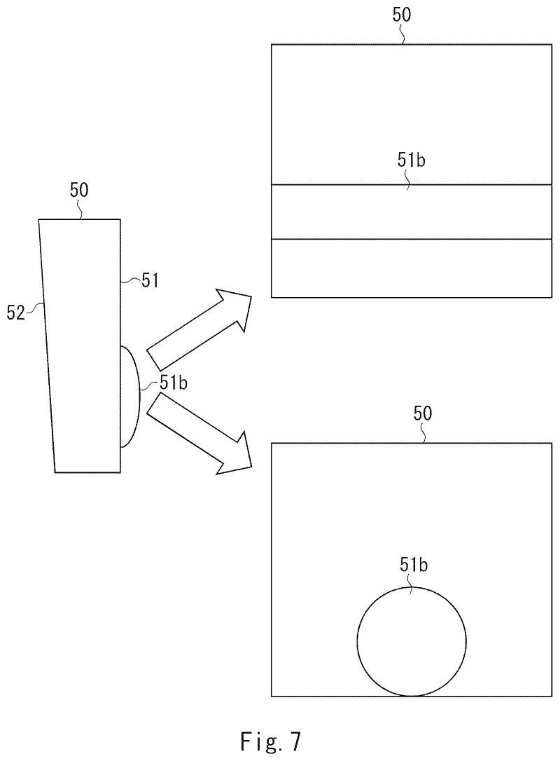

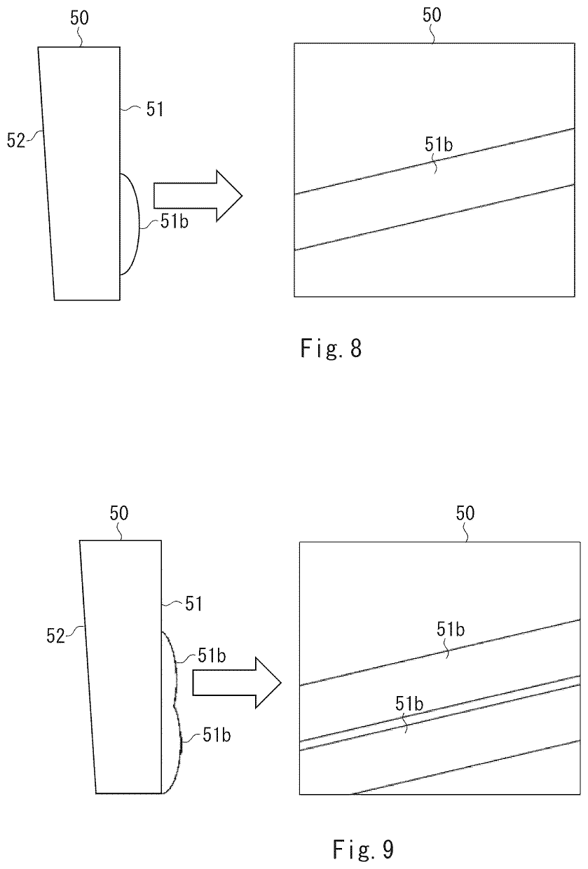

FIG. 7 illustrates a sixth modification of the optical element 50. FIG. 8 illustrates a seventh modification of the optical element 50. FIG. 9 illustrates an eighth modification of the optical element 50.

As illustrated in FIG. 7, an emission side optical surface 51b of the second region 50b may have a shape which is extended in one direction (see the upper part in FIG. 7) or may have a shape which is rotationally symmetrical with respect to the optical axis as a center (see the lower part in FIG. 7). This modification may appropriately be selected in accordance with manufacturing difficulty of the optical element and is also effective for size reduction.

In this case, the second optical surface 51b, which has a shape extended in one direction, of the second region 50b on the emission side may be arranged in parallel with the optical element 50 (see the upper part in FIG. 7) or may be arranged while being inclined with respect to the optical element 50 (see FIG. 8).

As illustrated in FIG. 9, one second optical surface 51b (see the upper part in FIG. 7 and FIG. 8) or a plurality of second optical surfaces 51b (see FIG. 9), each of which has a shape extended in one direction, of the second region 50b on the emission side may be provided.

The modifications illustrated in FIG. 8 and FIG. 9 are not limited to the emission side of the second region 50b and may be applied to any of regions on the incident side and the emission side of the first region 50a and the incident side of the second region 50b. Each of those modifications makes it easy to guide a ray regardless of an incident direction or an emission direction of the ray. In the above embodiment, a description is made about an example where as the light source 20, the light source module is used which emits one laser beam Ray1 resulting from combination (multiplexing) of the laser beams of three primary colors (RGB), but this is not restrictive. For example, as the light source 20, a light source module may be used which emits a laser beam of a single color.

In the above embodiment, a description is made about an example where the optical element of the present disclosure and the projection apparatus using that are applied to a laser scanning projector (or pico-projector), but this is not restrictive. For example, the optical element of the present disclosure and the projection apparatus using that may be applied to smart glasses, a super small-sized projector, an interactive projector, and LiDAR.

All numerical values indicated in the above embodiment are examples, and it goes without saying that appropriate numerical values different from those can be used.

The above embodiment is only an example in all respects. The present disclosure is not restrictively interpreted based on the descriptions about the above embodiment. The present disclosure can be carried out in various other forms without departing from the spirit and scope or the main features thereof.

What is claimed is:

1. An optical element being arranged between a light source and a light deflector reflecting and two-dimensionally deflecting incident light, the optical element comprising:
a first region on which light from the light source is caused to be incident and which emits the light to the light deflector; and
a second region which is different from the first region, on which light reflected and two-dimensionally deflected by the light deflector is incident, and which emits the light to an outside,
wherein an optical surface having a different optical action is provided on at least one side of an incident side and an emission side of the first region and an incident side and an emission side of the second region.

2. The optical element according to claim 1, wherein the optical surface is an optical surface having refractive power.

3. The optical element according to claim 1, wherein an optical surface having refractive power is provided at least on the emission side of the second region.

4. The optical element according to claim 1, wherein an optical surface having refractive power is provided at least on the incident side of the first region.

5. The optical element according to claim 1, wherein at least optical actions of the incident side of the first region and of the emission side of the second region are different from each other.

6. The optical element according to claim 1, wherein the optical element is configured by using at least two or more kinds of materials.

7. A projection apparatus comprising:
a light source;
a light deflector which reflects and two-dimensionally deflects incident light; and
the optical element according to claim 1.
